(19) United States
(12) Patent Application Publication
(10) Pub. No.: US 2026/0061343 A1
(43) Pub. Date: Mar. 5, 2026

(54) WATER FILTER WITH REPLACEABLE ACTIVE COMPONENTS

(71) Applicant: Blu Technology LLC, Kalamazoo, MI (US)

(72) Inventors: Corbin Collet, Kalamazoo, MI (US); Brian Brandon, Bellevue, MI (US)

(21) Appl. No.: 19/312,475

(22) Filed: Aug. 28, 2025

Related U.S. Application Data
(60) Provisional application No. 63/687,853, filed on Aug. 28, 2024.

(51) Int. Cl. B01D 24/12; B01D 15/00; B01D 35/30; B01D 36/02; B01D 39/20; C02F 1/00; C02F 1/28

(52) U.S. Cl. CPC B01D 24/12; B01D 15/00; B01D 35/301; B01D 36/02; B01D 39/2058; C02F 1/001; C02F 1/283; B01D 2201/301; B01D 2201/307; B01D 2201/347; B01D 2201/4092; C02F 2201/004; C02F 2201/006

(57) ABSTRACT

A water filtration system with replaceable active components. The water filtration system includes an outer housing, an inner filter canister, and a housing cap. The outer housing includes an inlet opening and an outlet opening. The housing cap includes a cap inlet opening. The inner filter canister filters water entering through the cap inlet opening. The outer housing retains and holds replaceable active filter components. The outer housing retains and holds the inner filter canister within the outer housing. The inner filter canister includes a connector for coupling to a connector on the underside of the housing cap. The housing cap engages with the inlet opening to secure the inner filter canister and the active filter components within the outer housing. Water exiting from the inner filter canister will be further filtered by the active filter components before exiting the outer housing via the outlet opening.

### CROSS REFERENCE TO RELATED APPLICATION

The present application claims the benefit of U.S. provisional application Ser. No. 63/687,853, filed Aug. 28, 2024, which is hereby incorporated herein by reference in its entirety.

### FIELD OF THE INVENTION

The present invention relates to water filtration, and in particular, to water filters with replaceable components.

### BACKGROUND OF THE INVENTION

Conventional filtration, such as sediment filtering and finer micron filtering have been used to filter water of sand, sediment, contaminants, etc. Water filtration systems are typically either whole house (multiple faucet) water filtration systems or single-faucet single-outlet water filtration systems. Other water filtration systems may be portable and optimized for size and weight allowing them to be carried along for use while hiking and/or camping. Such water filtration systems often contain filter components with limited lifespans or periods of usefulness.

### SUMMARY OF THE INVENTION

The present invention provides a water filtration system with replaceable active filter components for filtering water drawn into the water filtration system. Rather than replacing the entire filter (or an operative component assembly of a filter) when required, an exemplary water filtration system includes replaceable active components. Thus, when the filter system needs replacement, only the active components of the filter system (and not the entire filter or its operative component assembly) are replaced. The exemplary water filtration system includes a filter housing with a hollow interior and is configured to receive and retain a filter body within the hollow interior. The filter body includes a hollow inner chamber and a mesh lining. An outer surface of the filter body defines the size and shape of the hollow inner chamber. The hollow inner chamber is configured to receive and retain active filter components that are placed within the filter body. The hollow inner chamber comprises a plurality of portal openings configured to allow water to exit the hollow inner chamber. The mesh lining is arranged around, and in contact with, the outer surface of the filter body. The mesh lining is configured to retain the active filter components within the filter body, such that the mesh lining allows water to exit the inner chamber through the portals via openings in the mesh lining while not allowing the active filter components to exit the inner chamber through the portal openings.

According to one form of the present invention, an exemplary water filtration system includes a filter housing, a filter body, and a housing cap. The filter housing includes a threaded inlet opening and a threaded outlet opening. The filter body includes a flanged opening, a hollow inner chamber, and a plurality of portal openings. The portal openings are configured to allow water to exit from within the hollow inner chamber. The filter body further includes a mesh lining arranged around, and in contact with, an outer surface of the filter body. The hollow inner chamber is configured to retain and support active filter components within the hollow inner chamber. The mesh lining is configured to retain the active filter components within the filter body, such that the mesh lining allows water to exit the hollow inner chamber through the portal openings via openings in the mesh lining while not allowing the active filter components to exit the hollow inner chamber through the portal openings. The filter housing is configured to retain and hold the filter body within a hollow interior of the filter housing. The housing cap is configured to engage with the inlet threaded opening and when engaged, will secure the filter body within the outer housing.

In one aspect, the threaded inlet opening of the filter housing is configured to receive the filter body within the hollow interior of the filter housing.

In another aspect, the end of the filter housing opposite the threaded inlet opening includes a threaded outlet opening configured to receive a threaded outlet connector configured to receive an outlet tubing. The housing cap includes a threaded inlet opening configured to receive a threaded connector configured to receive an inlet tubing. The threaded inlet opening of the housing cap is configured to receive water for filtering, while the threaded outlet opening on the opposite side of the filter housing is configured to discharge filtered water from the filter housing.

According to another form of the present invention, an alternative exemplary water filtration system includes an outer housing, an inner filter canister, and a housing cap. The outer housing includes an inlet opening and an outlet opening. The inner filter canister filters water. The housing cap includes a cap inlet opening. The outer housing retains and holds the inner filter canister. The housing cap engages with the inlet opening of the outer housing and when so engaged, will secure the inner filter canister within the outer housing. The inner filter canister includes a threaded connector for coupling to a threaded connector on the underside of the housing cap, such that the inner filter canister is coupled to the housing cap. The outer housing retains and holds replaceable active filter components within the outer housing, such that water exiting the inner filter canister will be further filtered by the active filter components (via absorption of contaminants) before exiting the outer housing via the outlet opening.

In an aspect of the present embodiment, the cap inlet opening receives water for filtering by the water filtration system, while the outlet opening discharges filtered water.

In another aspect of the present embodiment, the filter housing includes a hollow interior for retaining and holding the inner filter canister. The hollow interior retains and holds the replaceable active filter components.

In a further aspect of the present embodiment, the inner filter canister includes a mesh layer surrounding the inner filter canister, such that an inner surface of the inner filter body is adjacent to an outer surface of the inner filter body. The mesh layer filters water flowing through the inner filter canister.

In yet another aspect of the present embodiment, the mesh layer retains particulate matter and/or contaminants larger than openings in the mesh layer within the inner filter canister while letting the filtered water pass out of the inner filter canister via a plurality of outlet portal openings in the mesh layer.

In an aspect of the present embodiment, the cap inlet opening and the outlet opening are threaded openings for receiving threaded connectors for coupling to water tubing.

In another aspect of the present embodiment, the housing cap disengages from the opening of the outer housing such that the activated components contained within the outer housing when needing to be refreshed can be removed and replaced. The activated components comprise granulated activated charcoal. The activated components are configured to filter the water via absorption of contaminants.

In yet another aspect of the present embodiment, the opening of the outer housing includes a gasket. The gasket seals the housing cap to the outer housing, such that the inner filter canister and the activated components are sealed within the outer housing and the engaged housing cap.

According to another form of the present invention, another alternative exemplary water filtration system includes an outer housing, an inner filter canister, and a housing cap. The outer housing includes an inlet opening and an outlet opening. The inner filter canister is configured to filter water. The housing cap includes a cap inlet opening. The outer housing is configured to retain and hold the inner filter canister. The housing cap is configured to engage with the inlet opening of the outer housing to secure the inner filter canister within the outer housing. The outer housing is configured to retain and hold replaceable active filter components within the outer housing, such that water existing from the outer housing via the outlet opening will be filtered by the active filter components before exiting the outer housing.

In an aspect of the present embodiment, the filter canister includes a threaded connector configured to couple to a threaded connector on the underside of the housing cap, such that the inner filter canister is coupled to the housing cap. The inner filter canister is configured such that filtered water exiting the inner filter canister will be further filtered by the active filter components before exiting the outer housing.

In another aspect of the present embodiment, the inner filter canister is configured to retain and hold the replaceable active filter components.

Thus, exemplary embodiments of the present invention provide for a water filtration system with replaceable active components configured to filter water via absorption of contaminants, such that a filter in need of replacement may be disassembled, the active components removed and replaced, and the filter reassembled.

These and other objects, advantages, purposes and features of this invention will become apparent upon review of the following specification in conjunction with the drawings.

### BRIEF DESCRIPTION OF THE DRAWINGS

FIG. 1 is a perspective view of an exemplary water filtration system with replaceable active components for filtering water drawn into the water filtration system in accordance with an embodiment of the present invention;

FIG. 2 is a perspective view of exemplary components of the water filtration system of FIG. 1 in accordance with an embodiment of the present invention;

FIG. 3 is a close-up perspective view of exemplary components of the water filtration system of FIG. 2 and illustrating an opening of the filter body in accordance with an embodiment of the present invention;

FIG. 4 is a close-up perspective view of an upper portion of an exemplary filter housing of the water filtration system of FIG. 2 and illustrating an opening of the filter housing in accordance with an embodiment of the present invention;

FIG. 5 is perspective view of the exemplary filter body of FIG. 3 in accordance with an embodiment of the present invention;

FIG. 6 is a perspective view of a housing cap coupled to an opening of the filter housing of the water filtration system of FIG. 1 in accordance with an embodiment of the present invention;

FIG. 7 is a perspective view of a threaded outlet connector adaptor coupled to a threaded outlet opening of the filter housing of the water filtration system of FIG. 1 in accordance with an embodiment of the present invention;

FIG. 8 is a perspective view of the water filtration system of FIG. 1 with the housing cap removed and illustrating the filling of the filter body with activated components in accordance with an embodiment of the present invention;

FIG. 9 is another perspective view of the housing cap coupled to the opening of the filter housing of the water filtration system of FIG. 6, and illustrating the housing cap restored after filling or refilling the filter body with activated components in accordance with an embodiment of the present invention;

FIG. 10 is another perspective view of the filter housing and housing cap separated from each other in accordance with an embodiment of the present invention;

FIGS. 11A and 11B are respective side and end views of the filter housing and the housing cap together and separated, respectively, in accordance with an embodiment of the present invention;

FIG. 12 illustrates a side view of an exemplary filter body with mesh lining in accordance with an embodiment of the present invention;

FIG. 13 is a perspective view of another exemplary water filter system with replaceable active components for filtering water drawn into the water filtration system in accordance with an embodiment of the present invention;

FIG. 14 is a perspective view of exemplary components of the water filtration system of FIG. 13 in accordance with an embodiment of the present invention;

FIG. 15A is a perspective view of an exemplary housing cap and an exemplary inner filter canister in accordance with an embodiment of the present invention;

FIG. 15B is a cross-section view of an exemplary inner filter canister coupled to an exemplary housing cap in accordance with an embodiment of the present invention;

FIG. 15C is a side view of an exemplary inner filter canister in accordance with an embodiment of the present invention;

FIG. 16 is a cross-section view of an exemplary water filter system illustrating several internal components in accordance with an embodiment of the present invention;

FIG. 17 is a close-up perspective view of an upper portion of an exemplary filter housing of the water filtration system of FIG. 14 and illustrating an opening in the filter housing in accordance with an embodiment of the present invention;

FIG. 18 is a perspective view of a housing cap coupled to an opening of the filter housing of the water filtration system of FIG. 13 in accordance with an embodiment of the present invention;

FIG. 19 is a perspective view of a threaded outlet connector adaptor coupled to a threaded outlet opening of the filter housing of the water filtration system of FIG. 13 in accordance with an embodiment of the present invention;

FIG. 20 is a perspective view of the water filtration system of FIG. 13 with the housing cap removed and illustrating the filling of the filter body with activated components in accordance with an embodiment of the present invention; and

FIG. 21 is another perspective view of the housing cap coupled to the opening of the filter housing of the water filtration system of FIG. 18 and illustrating the housing cap restored after filling or refilling the filter body with activated components in accordance with an embodiment of the present invention.

### DESCRIPTION OF THE PREFERRED EMBODIMENTS

Referring now to the drawings and illustrative embodiments depicted therein, an exemplary water filtration system provides water filtering with replaceable filter components, such as replaceable active components for water filter and/or water treatment. Exemplary active components for treating and/or filtering water include, for example, granulated activated charcoal (GAC), descaling agents for water softening, cation and/or anion exchange materials, biological components (for water treatment), caustic feed media (e.g., for adjusting pH levels), phosphate feed media (for controlling corrosion), other adsorptive media, and the like. Exemplary embodiments may include fixed as well as mobile systems. In one exemplary embodiment, the replaceable active components are retained within a filter body that is retained within a filter housing. In another exemplary embodiment, the filter housing retains and holds an inner filter canister and replaceable active components within a hollow chamber within the filter housing. The inner filter canister filters the water before the water is further filtered by the active components outside the inner filter canister.

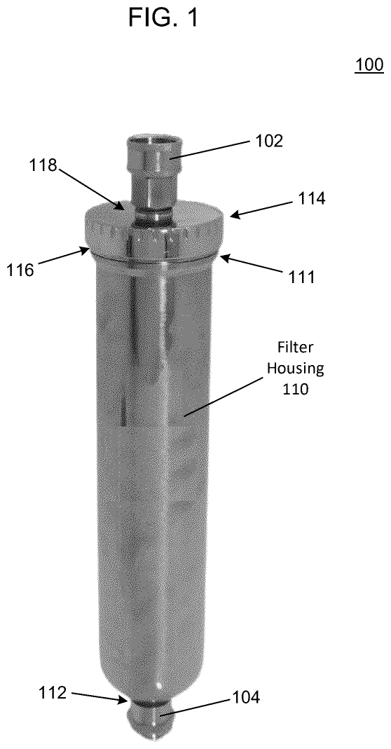

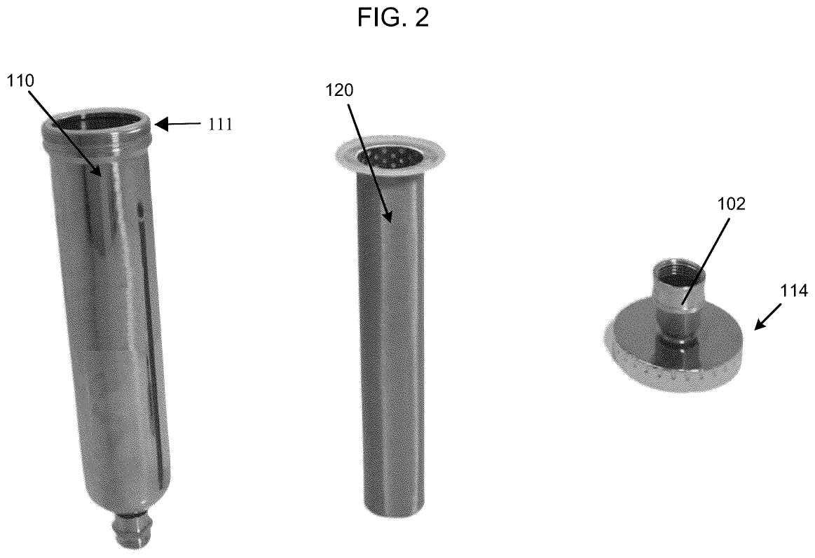

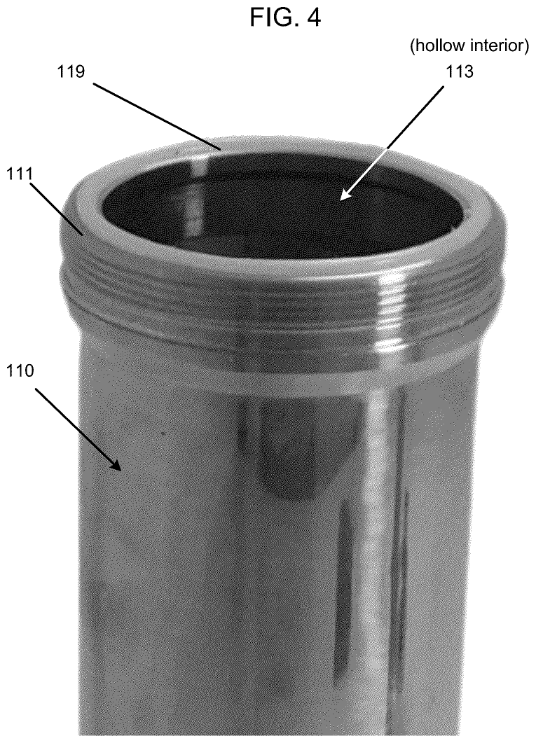

With reference to FIG. 1, an exemplary water filtration system 100 includes an outer filter housing 110 (which may be referred to as a “filter housing”), a housing cap 114, and a filter body 120. As discussed herein, the filter body 120 is retained and sealed within the filter housing 110 when the housing cap 114 is installed on the filter housing 110. As described herein, when “sealed,” the active ingredients or components retained in a hollow inner chamber (122) of the filter body 120 will be held within the filter housing 110 and will not leak (or otherwise escape) from the filter housing 110. Note that the seal between the filter housing 110 and the housing cap 114 is such that neither water nor active filter components will escape from the filter housing 110 via the seal between the housing cap 114 and the filter housing 110. In one exemplary embodiment, the water filtration system 100 includes a filter housing 110 with a pair of threaded openings (e.g., threaded inlet opening 111, and threaded output opening 112) on either end. As illustrated in FIGS. 2 and 4, the filter housing 110 has a hollow interior (e.g., hollow interior 113) configured to receive and retain a filter body 120.

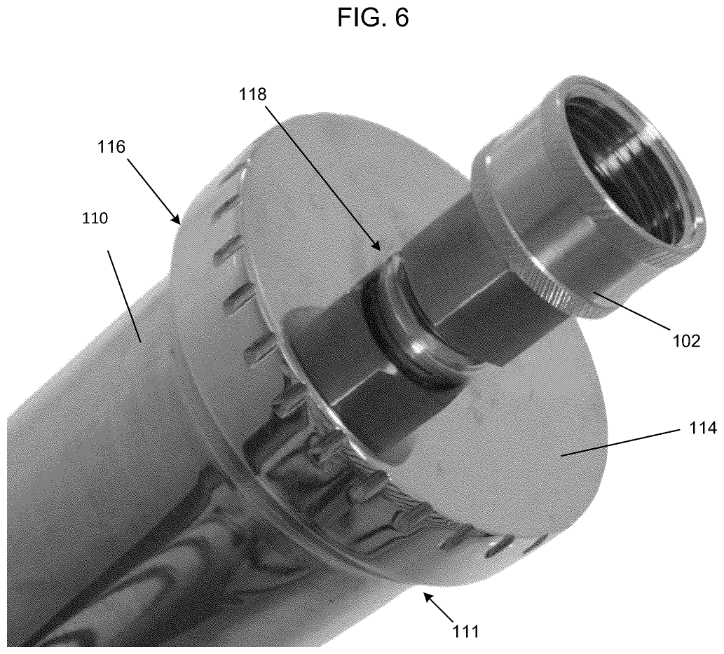

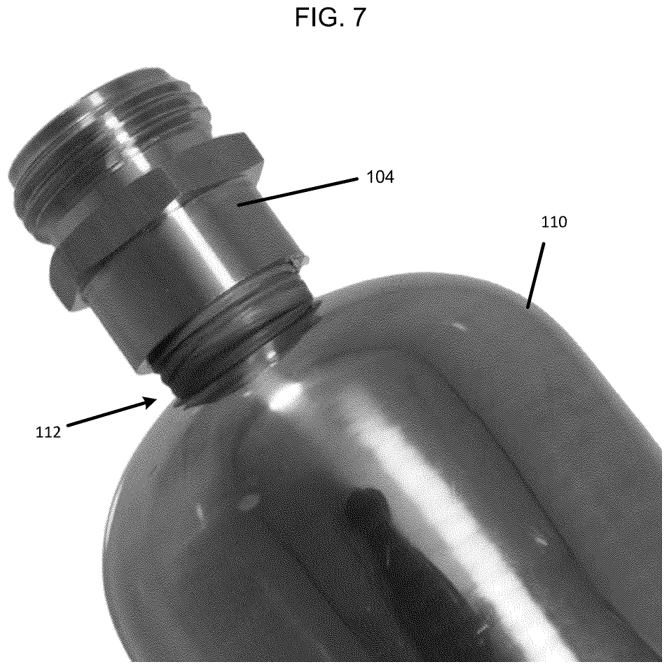

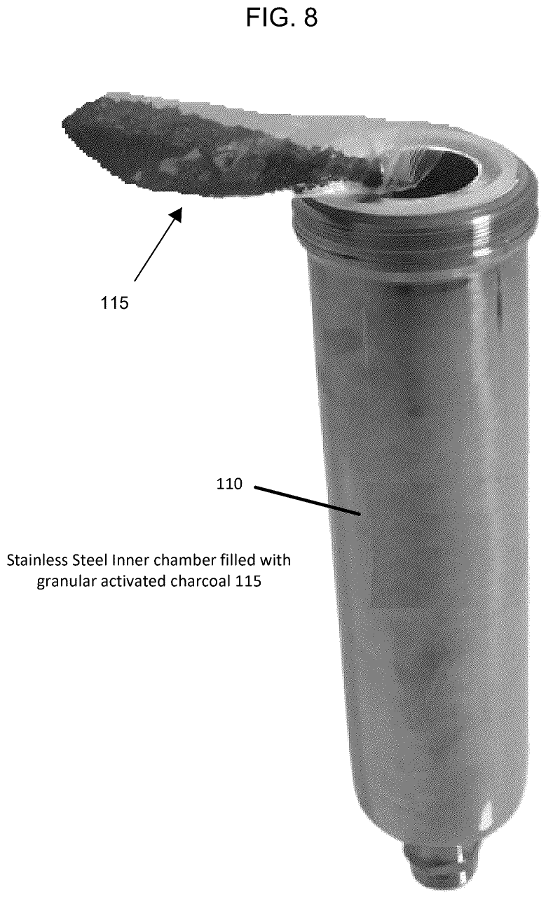

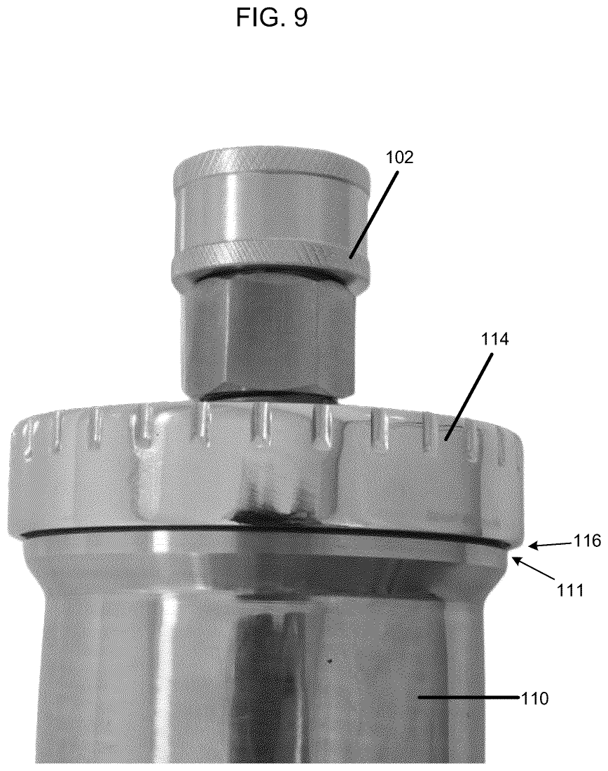

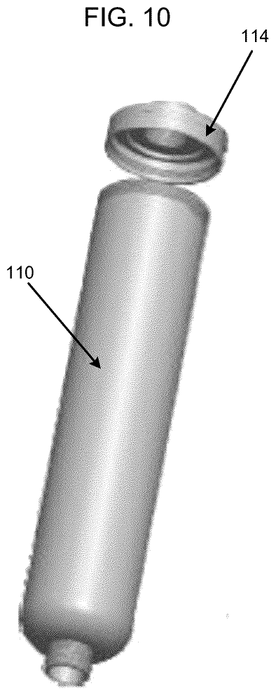

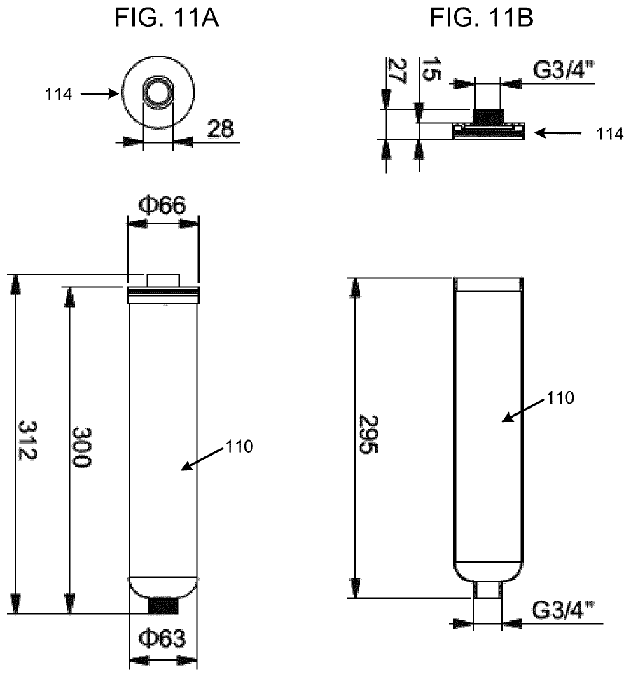

As illustrated in FIGS. 1, 2, 6, and 9, the filter housing 110 includes a threaded inlet opening 111 large enough to receive the filter body 120 (to enter the hollow interior 113). As illustrated in FIGS. 1, 2, and 7, the filter housing 110 also includes a threaded outlet opening 112 for outputting filtered water from the water filtration system 100.

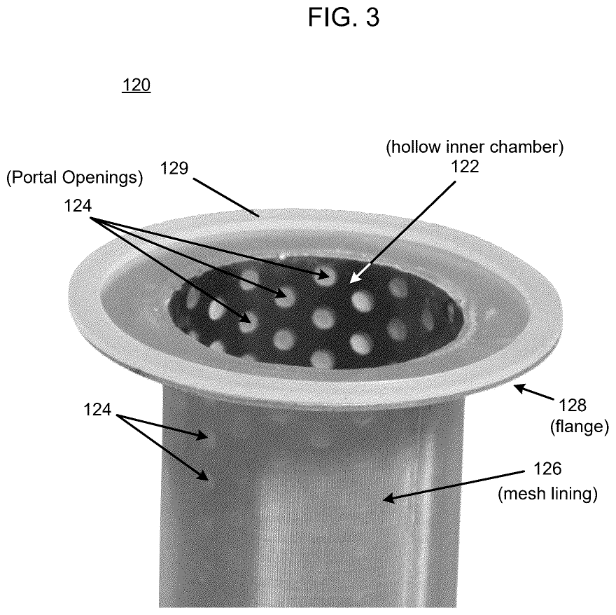

Referring to FIGS. 1, 2, 6, and 9, the housing cap 114 includes a threaded opening 116 configured to engage with threads of the threaded inlet opening 111, such that the housing cap 114, once threaded onto the threaded inlet opening 111 of the filter housing 110 (via the threads of the threaded inlet opening 111), is configured to retain the filter body 120 within the filter housing 110. Note that both the threaded inlet opening 111 of the filter housing 110, and the flange 128 of the filter body 120 include gaskets 119, 129 arranged around respective outer perimeters of the threaded inlet opening 111 and the flange 128, respectively (see FIGS. 3 and 4). The gaskets 119, 129 seal the active filter components within the filter housing 110 and also prevent water from leaking from the filter housing 110 and housing cap 114 connection point (via their respective threaded connections). As illustrated in FIGS. 3 and 4, when the gaskets 119, 129 are in place, securing the housing cap 114 to the filter housing 110 will engage the gasket 119 between threaded inlet opening 111 and the underside of the flange 128, and the gasket 129 between the topside of the flange 128 and an interior surface of the housing cap 114, such that the filter body 120 (and the activated components 115 contained within) is sealed within the filter housing 110 and attached housing cap 114. In one embodiment, the activated components 115 comprise activated carbon (e.g., activated charcoal). Such activated components 115 may have a granular consistency (i.e., a granular activated charcoal or “GAC”). Such exemplary activated components (e.g., granular activated charcoal) are configured to filter water by trapping particulate matter or contaminants from the water via absorption via highly porous surfaces (of the activated components). In other embodiments, the activated components 115 comprise any of a variety of agents for treating water, for example, granular activated charcoal (GAC), descaling agents for water softening, iron filtration media, cation and/or anion exchange materials, biological components (for water treatment), caustic feed media (e.g., for adjusting pH levels), phosphate feed media (for controlling corrosion), other adsorptive media, and the like.

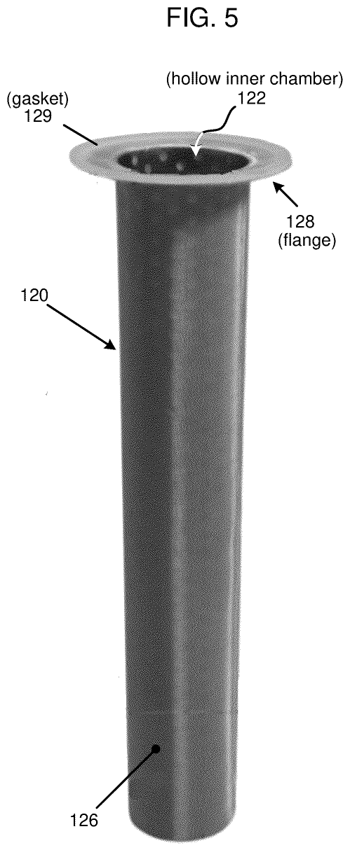

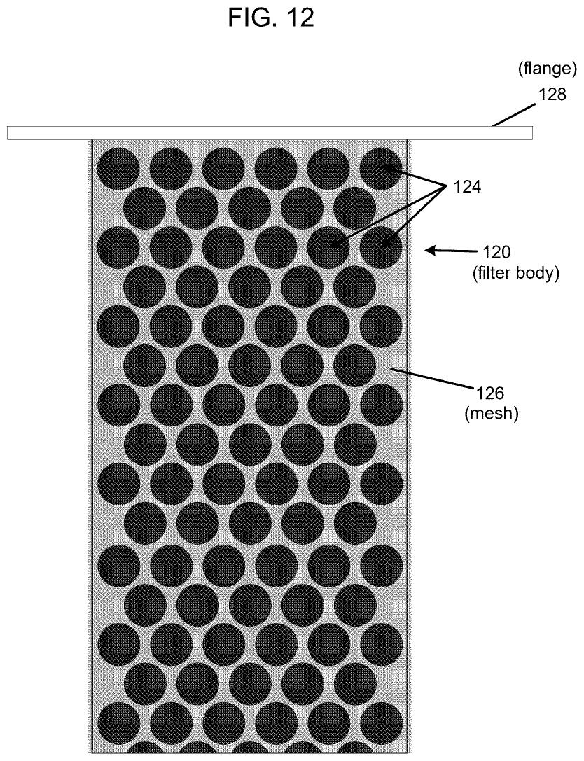

With reference to FIGS. 2, 3, 5, and 12, in one exemplary embodiment, the filter body 120 is formed as a hollow metallic tube with a plurality of openings (“portal openings”) 124 arranged around the shaft or length of the filter body 120. As illustrated in FIGS. 2, 3, and 5, the filter body 120 is formed with a hollow interior (i.e., the hollow inner chamber 122). In one embodiment, the filter body 120 is formed from stainless steel. As described herein, the portal openings 124 allow for easy passage of water from the hollow inner chamber 122 of the filter body 120, but with active filter components 115 prevented from exiting the hollow inner chamber 122 of the filter body 120 (via the portal openings 124) by a mesh lining 126 which surrounds the exterior of the filter body 120 (see FIG. 12).

In one embodiment, an exemplary mesh lining 126 is formed of, for example, a stainless steel 500 mesh, such that the mesh lining 126 is formed with 20-micron (or smaller) openings. Other selections of stainless steel are also anticipated. As discussed herein, such openings in the mesh lining 126 allow filtered water to pass through but retain the active filter components 115 within the hollow inner chamber 122 of the filter body 120 (i.e., water is allowed to pass through the portal openings 124 but the activated components 115 are retained in the hollow inner chamber 122). The mesh lining 126 could be formed using other materials as well (e.g., other metals, plastics, and the like) with 20-micron openings sufficient to retain the activated components 115 (as well as other particulate matter and/or contaminants in the water that haven't been otherwise absorbed by the GAC 115) while allowing water to pass through. Thus, water entering via the inlet cap opening 118 will pass through the filter body 120 and be filtered by the activated components 115 within the filter body 120, before exiting via the outlet opening 112.

As illustrated in FIGS. 2, 3, 5, and 12, the mesh lining 126 is sized and arranged against an outer surface of the filter body 120 such that an inner surface of the mesh lining 126 will be adjacent the outer surface of the filter body 120, such that active components (and any particulate matter and/or contaminants in the water not otherwise absorbed by the GAC 115) are retained within the filter body 120 and not allowed to exit via the portal openings 124.

In an alternative embodiment, the mesh lining 126 is an internal mesh that is sized and arranged against an inner surface of the filter body 120 such that an outer surface of the mesh lining 126 will be adjacent to the inner surface of the filter body 120, such that active components (and any particulates or contaminants not otherwise absorbed by the GAC 115) are retained within the filter body 120 and not allowed to exit via the portal openings 124.

Note that the inlet cap opening 118 and/or the outlet opening 112 can include connector adaptors 102, 104, respectively. As illustrated in FIGS. 1, 2, 6, 7, and 9, the inlet cap opening 118 and outlet opening 112 can be threaded for either direct coupling to water lines, or for coupling to threaded embodiments of the connector adaptors 102, 104. In one embodiment, the connector adaptors 102, 104 are any of a variety of different connector adaptors, such as quick-connect couplers, push-to-connect couplers, threaded couplers (e.g., garden hose thread (GHT) and national pipe taper (NPT) threaded couplers), and the like.

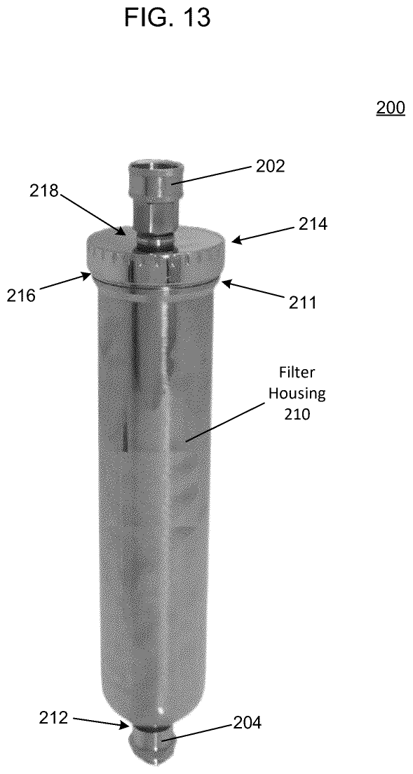

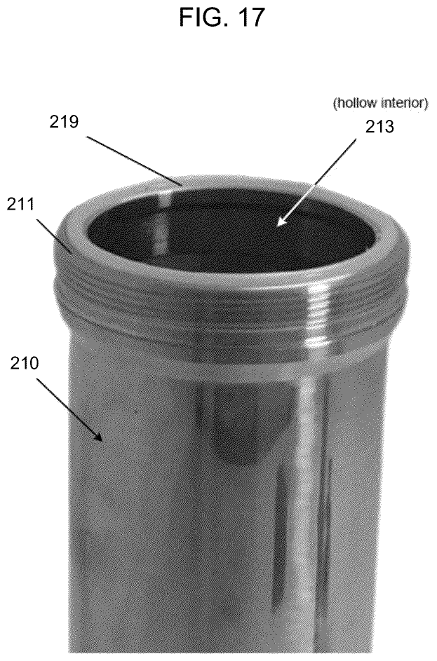

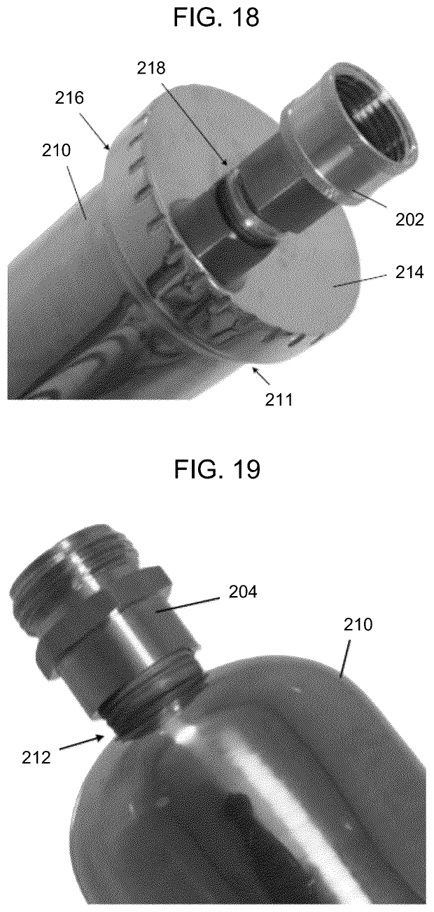

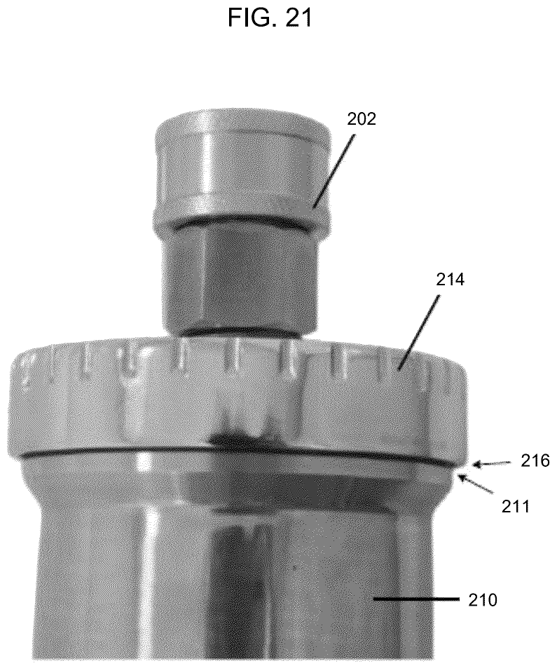

Referring to FIGS. 13-21, in an alternative embodiment, an exemplary water filtration system 200 includes an outer filter housing 210 (which may be referred to as a “filter housing”), a housing cap 214, and an inner filter canister 220. As discussed herein, the inner filter canister 220 and user replaceable active filter components (e.g., granular activated charcoal (GAC)) 115 are retained and sealed within the filter housing 210 when the housing cap 214 is installed on the filter housing 210. As described herein, when “sealed,” the active ingredients or components retained within a hollow interior 213 of the filter housing 210 will be held within the filter housing 210 and will not leak (or otherwise escape) from the filter housing 210. Note that the seal between the filter housing 210 and the housing cap 214 is such that neither water nor active filter components (115) will escape from the filter housing 210 via the seal between the housing cap 214 and the filter housing 210.

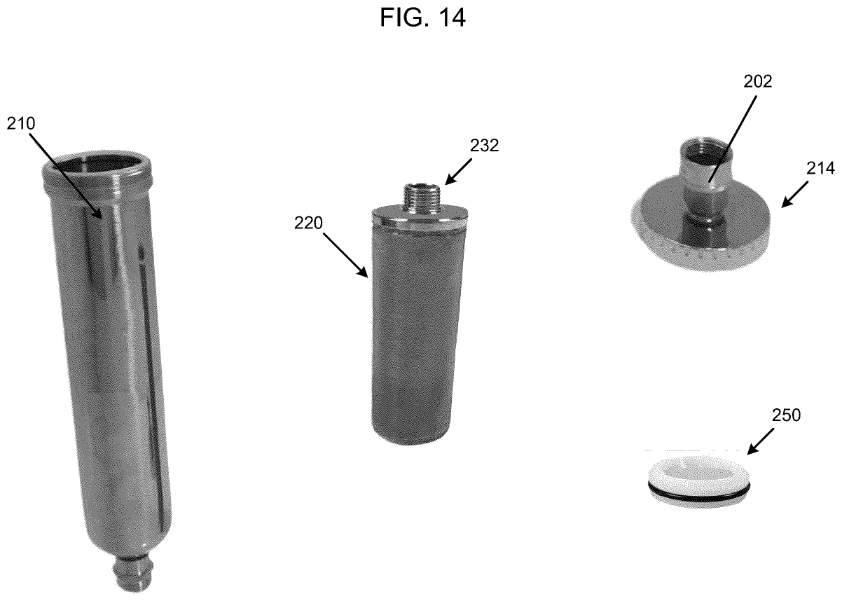

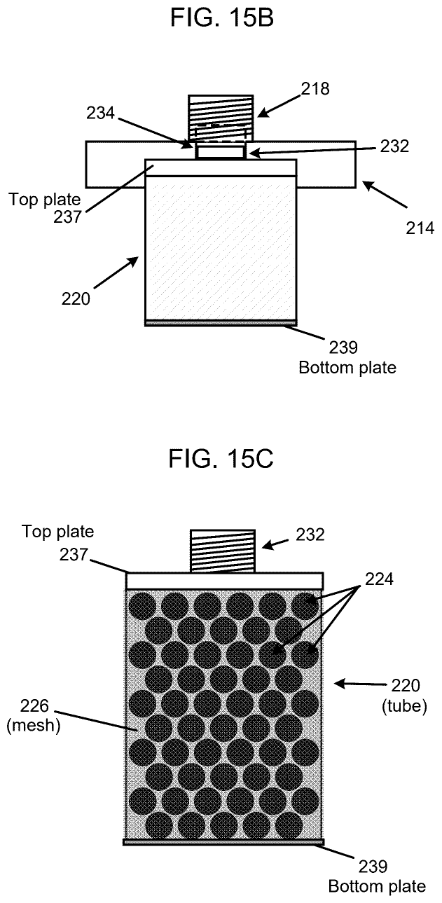

In one exemplary embodiment, the water filtration system 200 comprises a filter housing 210 with a pair of threaded openings 211, 212 on either end. As illustrated in FIGS. 14, 16, and 17, the filter housing 210 has a hollow interior (e.g., hollow interior 213) configured to receive and retain the inner filter canister 220 and a filter disc 250. As illustrated in FIG. 16, the filter disc 250 is positioned at the bottom of the hollow interior 213 of the filter housing 210 and retains the GAC 115 with the hollow interior 213. As illustrated in FIGS. 13, 14, 15A, 15B, 15C, and 16, the inner filter canister 220 includes a threaded connector 232 configured to screw into the underside of a housing cap 214 (via a threaded connector 234). With the housing cap 214 (and inner filter canister 220) screwed down onto a filter housing 210, the inner filter canister 220 will be retained within the hollow interior 213 of the filter housing 210 along with the GAC 115.

As illustrated in FIGS. 13, 16, and 17, the filter housing 210 includes a threaded inlet opening 211 large enough to receive the inner filter canister (retained within the hollow interior 213). As illustrated in FIGS. 13, 14, and 19, the filter housing 210 also includes a threaded outlet opening 212 for outputting filtered water from the water filtration system 200.

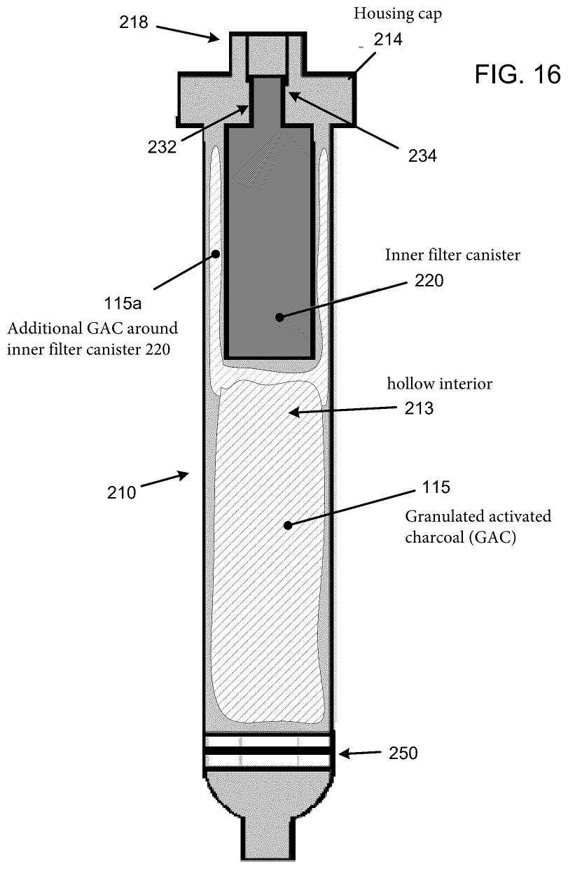

As illustrated in FIGS. 13, 14, 17, 18, and 21, the housing cap 214 includes a threaded opening 216 configured to engage with the threads of the threaded inlet opening 211, such that the housing cap 214, once threaded onto the threaded inlet opening 211 of the filter housing 210 (via the threads of the threaded inlet opening 211), is configured to retain the inner filter canister 220 within the filter housing 210. Note that the threaded inlet opening 211 of the filter housing 210 includes a gasket 219 arranged around the outer perimeter of the threaded inlet opening 111 (see FIG. 17). The gasket 219 seals the active filter components (115) within the filter housing 210 and also prevents water from leaking from the filter housing 210 and the housing cap 214 connection point (via their threaded connection). As illustrated in FIGS. 13, 17, 18, and 21, when the gasket 219 is in place, securing the housing cap 214 to the filter housing 210 will engage the gasket 219 between the threaded inlet opening 211 and an interior surface of the housing cap 214, such that the inner filter canister 220 and the GAC components 115 are sealed within the filter housing 210 and the attached housing cap 214. As discussed herein, the activated components 115 comprise activated carbon (e.g., activated charcoal). Such activated components 115 may have a granular consistency (i.e., a granular activated charcoal). As discussed herein, the activated components or granulated activated charcoal (“GAC”) 115 is poured into the hollow interior 213 of the filter housing 210 to filter the water as it flows through the filter housing 210 of the water filtration system 200 (after an initial filtering by the inner filter canister 220). Such exemplary activated components (e.g., granular activated charcoal) 115 are configured to filter water by trapping particulate matter or contaminants from the water via absorption via highly porous surfaces (of the activated components). In other embodiments, the activated components 115 comprise any of a variety of agents for treating water, for example, granular activated charcoal (GAC), descaling agents for water softening, iron filtration media, cation and/or anion exchange materials, biological components (for water treatment), caustic feed media (e.g., for adjusting pH levels), phosphate feed media (for controlling corrosion), other adsorptive media, and the like.

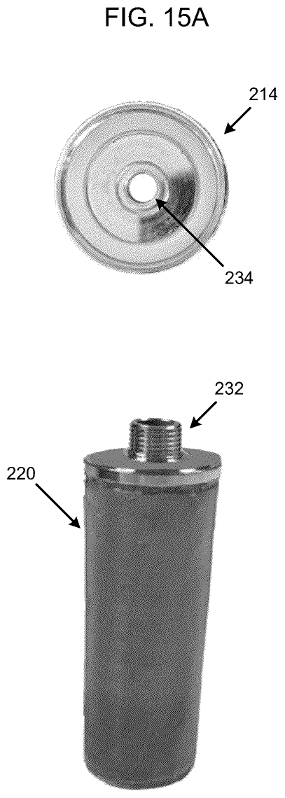

Referring to FIGS. 15A, 15B, and 15C, an exemplary inner filter canister 220 includes a top plate 237 and a bottom plate 239, with a mesh lining 226 covering the outer surface of a hollow metallic tube with a plurality of openings (“portal openings”) 224 arranged around the shaft or length of the tube of the inner filter canister 220. The inner filter canister 220 is formed with a hollow interior (defined by the top plate 237, the bottom plate 239, and the metallic tube connecting them together). In one embodiment, the inner filter canister 220 is formed of stainless steel. As described herein, the portal openings 224 allow for easy passage of water from the inner filter canister 220, with a mesh lining 226 which surrounds the exterior of the hollow metallic tube of the inner filter canister 220 “filtering” out particulate matter or contaminants larger than the openings of the mesh lining 226 (see FIGS. 14, 15A, 15B, and 15C). In one embodiment, the mesh lining 226 is formed of, for example, a stainless steel 500 mesh, such that the mesh lining 226 is formed with 20-micron (or smaller) openings. Other selections of stainless steel are also anticipated. The mesh lining 226 could be formed using other materials (e.g., other metals, plastics, and the like) with 20-micron openings sufficient to retain particulate matter or contaminants while allowing the water to pass through. In one embodiment, the mesh lining 226 is sized and arranged against an outer surface of the inner filter canister 220 such that an inner surface of the mesh lining 226 will be adjacent the outer surface of the inner filter canister 220, such that particulate matter or contaminants larger than 20 microns are retained within the inner filter canister 220 and not allowed to exit via the portal openings 224. Thus, water entering via the inlet cap opening 218 will pass through the filter housing 220 and be filtered first by the inner filter canister 220 and then further filtered by the GAC 115 within the filter housing 220 before exiting via an outlet opening 212.

In an alternative embodiment, the mesh lining 226 is an internal mesh lining that is sized and arranged against an inner surface of the inner filter canister 220 such that an outer surface of the mesh lining 226 will be adjacent to the inner surface of the inner filter canister 220, such that particulate matter or contaminants larger than 20 microns are retained within the inner filter canister 220 and not allowed to exit via the portal openings 224. Thus, water entering via the inlet cap opening 218 will pass through the filter housing 220 and be filtered first by the inner filter canister 220 and then further filtered by the GAC 115 within the filter housing 220 before exiting via an outlet opening.

As illustrated in FIGS. 15B and 16, a threaded connector 232 of the inner filter canister 220 is screwed into a threaded connector 234 on the underside of the housing cap 214. In one embodiment, once screwed together, the inner filter canister 220 and the housing cap 214 are a single unit.

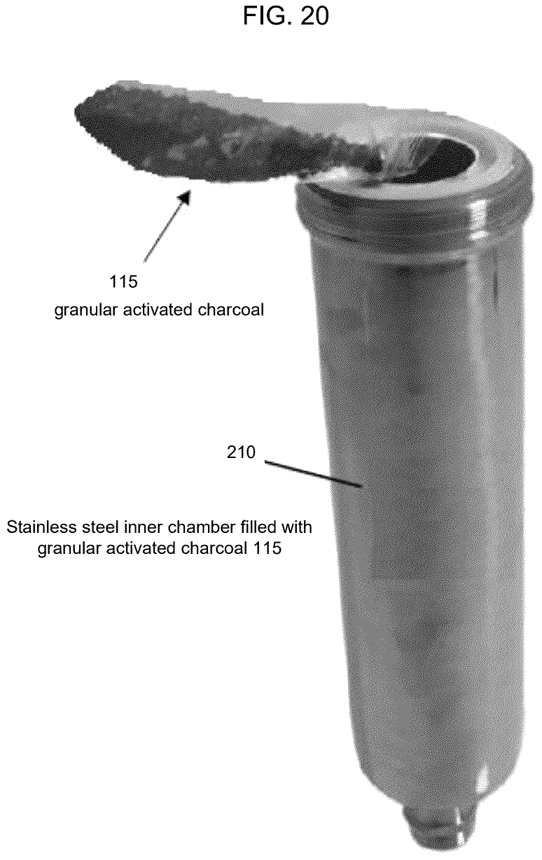

Referring to FIGS. 16 and 20, the hollow interior 213 of the filter housing 210 is filled with active filter components (e.g., granulated activated charcoal (GAC)) 115. In one embodiment, the GAC 115 fills the hollow interior 213 up to the inner filter canister 220. In another embodiment, the GAC 115 fills the hollow interior 213 up to the inner filter canister 220, and additional GAC 115a surrounds the inner filter canister 220, such that when water exits the inner filter canister 220, the water will immediately encounter the GAC 115a surrounding the inner filter canister 220. With active filter components 115 added to the hollow interior 213 of the filter housing 210, when the housing cap 214 (with attached inner filter canister 220) is screwed onto the filter housing 210, the inner filter canister 220 will be pushed down onto and optionally into the granular activated charcoal (GAC) 115. When there is a sufficient amount of GAC 115 in the filter housing 210, the inner filter canister 220 can be pushed into the GAC 115 such that the GAC 115 is pushed up around the sides of the inner filter canister 220 to at least partially bury the inner filter canister 220 in the GAC 115.

With further reference to FIG. 16, the filter disc 250 may be positioned at the bottom of the hollow interior 213 of the filter housing 210 (before the GAC 115 is added to the filter housing 210). The filter disc 250 is used to retain the GAC 115 in the hollow interior 213 of the filter housing 210. An exemplary filter disc 250 is formed of a stainless-steel mesh, and an outer plastic retaining ring and rubber gasket for sealing the filter disc 250 against the walls of the hollow interior 213 (see FIGS. 14 and 16). In one embodiment, the filter disc 250 is formed of a stainless-steel mesh with 20 micron or smaller openings. In another embodiment, the filter disc 250 is formed of a stainless-steel mesh with openings sized to retain the individual granules of the granular activated charcoal 115.

Similar to the embodiments discussed herein, when the filter components 115 (e.g., GAC) need to be replaced, the housing cap 214 (with attached inner filter canister 220) can be unscrewed from the filter housing 210 and the old GAC material 115 removed and replaced with fresh filter components. When the housing cap 214 and attached inner filter canister 220 are removed from the filter housing 210, the inner filter canister 220 can be rinsed out by running water through the inner filter canister 220, which will be emptied out through the inlet cap opening 218 of the housing cap 214.

Note that the inlet cap opening 218 and/or the outlet opening 212 can include connector adaptors 202, 204, respectively. As illustrated in FIGS. 13, 14, 18, 19, and 21, the inlet cap opening 218 and outlet opening 212 can be threaded for either direct coupling to water lines, or for coupling to threaded embodiments of the connector adaptors 202, 204. In one embodiment, the connector adaptors 202, 204 are any of a variety of different connector adaptors, such as quick-connect couplers, push-to-connect couplers, threaded couplers (e.g., garden hose thread (GHT) and national pipe taper (NPT) threaded couplers), and the like.

Changes and modifications in the specifically described embodiments can be carried out without departing from the principles of the present invention which is intended to be limited only by the scope of the appended claims, as interpreted according to the principles of patent law including the doctrine of equivalents.

1. A water filtration system with replaceable active components comprises:
an outer housing comprising an inlet opening and an outlet opening;
an inner filter body configured to retain and hold replaceable active filter components; and
a housing cap comprising a cap inlet opening;
wherein the outer housing is configured to retain and hold the inner filter body within the outer housing;
wherein the inner filter body comprises a flanged opening and a plurality of outlet portal openings; and
wherein the housing cap is configured to engage with an opening in the outer housing and when so engaged will secure the inner filter body within the outer housing.

2. The water filtration system of claim 1, wherein the cap inlet opening is configured to receive water for filtering by the water filtration system, and wherein the outlet opening is configured to discharge filtered water.

3. The water filtration system of claim 1, wherein the filter housing comprises a hollow interior configured to retain and hold the inner filter body.

4. The water filtration system of claim 1, wherein the inner filter body comprises a mesh layer configured to surround the inner filter body, such that an inner surface of the inner filter body is adjacent to an outer surface of the inner filter body.

5. The water filtration system of claim 4, wherein the mesh layer is configured to retain the active filter components within the inner filter body while letting the filtered water pass out of the inner filter body via the plurality of outlet portal openings.

6. The water filtration system of claim 1, wherein the cap inlet opening and the outlet opening are threaded openings configured to receive threaded connectors configured to receive water tubing.

7. The water filtration system of claim 1, wherein the housing cap is configured to disengage from the inlet opening such that the activated components contained within the inner filter body can be removed and replaced.

8. The water filtration system of claim 1, wherein the activated components comprise granulated activated charcoal, and wherein the activated components are configured to filter the water via absorption of contaminants.

9. The water filtration system of claim 1, wherein the inlet opening of the outer housing and the flanged opening of the inner filter body comprise gaskets, wherein the gaskets are configured to seal the housing cap to the outer housing, such that the inner filter body is sealed within the outer housing and engaged housing cap.

10. A water filtration system with replaceable active components comprises:
an outer housing comprising an inlet opening and an outlet opening;
an inner filter canister configured to filter water; and
a housing cap comprising a cap inlet opening;
wherein the outer housing is configured to retain and hold the inner filter canister;
wherein the housing cap is configured to engage with the inlet opening of the outer housing and when so engaged will secure the inner filter canister within the outer housing;
wherein the inner filter canister comprises a threaded connector configured to couple to a threaded connector on the underside of the housing cap, such that the inner filter canister is coupled to the housing cap; and
wherein the outer housing is configured to retain and hold replaceable active filter components within the outer housing, such that water exiting the inner filter canister will be further filtered by the active filter components before exiting the outer housing via the outlet opening.

11. The water filtration system of claim 10, wherein the cap inlet opening is configured to receive water for filtering by the water filtration system, and wherein the outlet opening is configured to discharge filtered water.

12. The water filtration system of claim 10, wherein the filter housing comprises a hollow interior configured to retain and hold the inner filter canister, and wherein the hollow interior is further configured to retain and hold the replaceable active filter components.

13. The water filtration system of claim 10, wherein the inner filter canister comprises a mesh layer configured to surround the inner filter canister, such that an inner surface of the inner filter body is adjacent to an outer surface of the inner filter body, wherein the mesh layer is configured to filter water flowing through the inner filter canister, and wherein the mesh layer is configured to retain particulate matter larger than openings in the mesh layer within the inner filter canister while letting the filtered water pass out of the inner filter canister via a plurality of outlet portal openings in the mesh layer.

14. The water filtration system of claim 10, wherein the cap inlet opening and the outlet opening are threaded openings configured to receive threaded connectors configured to receive water tubing.

15. The water filtration system of claim 10, wherein the housing cap is configured to disengage from the opening of the outer housing such that the activated components contained within the outer housing can be removed and replaced.

16. The water filtration system of claim 10, wherein the activated components comprise granulated activated charcoal, and wherein the activated components are configured to filter the water via absorption of contaminants.

17. The water filtration system of claim 1, wherein the opening of the outer housing comprises a gasket, wherein the gasket is configured to seal the housing cap to the outer housing, such that the inner filter canister and the activated components are sealed within the outer housing and the engaged housing cap.

18. A water filtration system with replaceable active components comprises:
an outer housing comprising an inlet opening and an outlet opening;
an inner filter canister configured to filter water; and
a housing cap comprising a cap inlet opening;
wherein the outer housing is configured to retain and hold the inner filter canister;
wherein the housing cap is configured to engage with the inlet opening of the outer housing and when so engaged will secure the inner filter canister within the outer housing; and
wherein the outer housing is configured to retain and hold replaceable active filter components within the outer housing, such that water exiting the outer housing via the outlet opening will be filtered by the active filter components before exiting the outer housing.

19. The water filtration system of claim 18, wherein the inner filter canister comprises a threaded connector configured to couple to a threaded connector on the underside of the housing cap, such that the inner filter canister is coupled to the housing cap, and wherein the inner filter canister is configured such that filtered water exiting the inner filter canister will be further filtered by the active filter components before exiting the outer housing.

20. The water filtration system of claim 18, wherein the inner filter canister is configured to retain and hold the replaceable active filter components.
